(19) United States
(12) Patent Application Publication
(10) Pub. No.: US 2026/0025650 A1
(43) Pub. Date: Jan. 22, 2026

(54) METHOD FOR CONFIGURING A USER DEVICE, CONFIGURATION PROGRAM, COMPUTER-READABLE DATA CARRIER, USER DEVICE, AND CONFIGURATION ARRANGEMENT THEREFOR

(71) Applicant: Giesecke+Devrient Mobile Security Germany GmbH, Munchen (DE)

(72) Inventor: Michael Schnellinger, Munich (DE)

(73) Assignee: Giesecke+Devrient Mobile Security Germany GmbH, Munchen (DE)

(21) Appl. No.: 19/275,664

(22) Filed: Jul. 21, 2025

(30) Foreign Application Priority Data
Jul. 22, 2024 (DE) 102024120757.4

(51) Int. Cl. H04W 8/20; H04W 12/30

(52) U.S. Cl. CPC H04W 8/205; H04W 12/35

(57) ABSTRACT

A method and system for configuring a user device for participation in a telecommunications network are disclosed, with a secure element, such as an eUICC, which is configured to administrate at least one profile dataset for secure operation of the user device. An installation dataset is provided for accompanying at least part of an installation process for installing data on the secure element. An auxiliary profile data set is provided to enable access to a telecommunications network.

### CROSS REFERENCE TO RELATED DOCUMENT(S)

This application claims priority to DE Application No. DE 10 2024 120 757.4 entitled “Method for configuring a user device, configuration program, computer-readable data carrier, user device, and configuration arrangement therefor” and filed on Jul. 22, 2024, which application is incorporated by reference in its entirety.

### TECHNICAL FIELD

The present disclosure relates to the setup of user devices with secure elements, and more particularly, for communication via networks during the installation of updates.

### BACKGROUND

Methods for handling embedded secure elements, such as eUICCs, as well as computer programs, computer-readable data carriers, user devices for participation in communication networks, and communication networks are known. For example, eUICCs on mobile user devices such as mobile phones, smartphones, tablets, or similar, respective identification features of users of the user devices are administrated. On an eUICC, this may be done in the form of a corresponding embedded subscriber identity modules (eSIM). This procedure is to meet the security requirements necessary for managing the identification features.

Secure elements typically have a system structure with an operating system that allows them to interact with device assemblies of end devices on which they are implemented. The operating system provides access to memory areas, usually non-volatile memory, of secure elements, and information stored therein, such as identification features, can be handled, managed, and queried. This is done, for example, using data elements of corresponding application protocols (Application Protocol Data Unit—APDU), which transmit commands unidirectionally to secure elements via a connection interface, where they are then executed.

### SUMMARY

Methods and systems are disclosed herein for configuring a user device, for example a mobile user device for participation in a telecommunications network, with a secure element, in particular an eUICC, which is configured to administrate at least one profile data set for secure operation of the user device, comprising the following steps: providing an installation data set for accompanying at least part of an installation process for installing data on the secure element; and providing an auxiliary profile data set enabling access to a telecommunications network while the installation data set accompanies at least part of the installation process.

A configuration program with instructions which, when executed by a user device, cause the user device to execute a corresponding method.

A computer-readable data carrier are disclosed with a corresponding configuration program stored thereon according to the claim.

A User device, in particular a mobile terminal device for participation in a communications network, are disclosed with a corresponding configuration program according to a computer-readable data carrier and/or for executing a corresponding method.

A configuration arrangement is disclosed for configuring user devices, with a corresponding configuration program stored therein, a corresponding computer-readable data carrier and/or for executing a corresponding method.

A method can be executed accordingly by a data processing device or with the aid of a computer, which can be implemented as a user device or server. A configuration or computer program can comprise commands which, when the program is executed by a data processing device or a computer, cause the latter to carry out the method. A computer-readable storage medium, a computer-readable data carrier, and/or a data carrier signal can store or transmit the configuration or computer program. A corresponding computer-readable data carrier can be provided as a computer-readable medium and/or data carrier signal.

The installation data set can help administrate and/or control the installation process. For example, the installation data set can be a so-called Image Trusted Loader (ITL). The installation process can be an update process, such as updating an operating system of the secure element. The configuration arrangement can include a server device for configuring user devices.

An embodiment can include that the auxiliary profile data set can enable access to communication networks while the installation data set installs data on the secure element, such as an update of the operating system. In this way, the operability, availability, and/or data integrity, in particular the communication capability of the user devices or their secure elements, can be ensured during ongoing installation processes. This helps to provide the secure elements or user devices with the greatest possible continuous availability or at least improve their availability to such an extent that any interruptions in availability are within an acceptable time frame.

The solution is not limited to eUICCs but is generally suitable for so-called secure elements (SEs) or tamper-resistant elements (TREs), which are referred to here as integrated circuit cards, for example. As such, secure elements include, in addition to eUICCs, classic UICCs, integrated UICCs (iUICCs), and all integrated secure elements of other designs, such as integrated secure elements (iSE/eSE), smart cards, subscriber identity modules, subscriber identity modules (SIMs), and/or virtual SIMs (vSIMs). All such secure elements have in common that user datasets or eUICC datasets, for example in the form of telecommunications profiles or “profiles” for short, can be stored on them, which users can use to authenticate themselves to communication networks, for example as subscribers in telecommunications networks. The secure elements are characterized by the fact that the information stored on them, in particular the profiles, is specially protected against attacks by third parties and cannot be easily manipulated either physically or by means of software.

According to an embodiment, the installation dataset may be configured to carry out the installation process in a memory area of the secure element and, during this process, to store the auxiliary profile dataset in another memory area of the secure element. This allows the installation process to be carried out in the appropriately assigned memory area in accordance with the respective requirements without affecting the auxiliary profile dataset stored in another memory area. In this way, the availability and data integrity of secure elements can be further improved during the execution of installation processes.

According to an embodiment, the installation dataset may be configured to store the login credentials required for creating the auxiliary profile dataset in a section of a secure storage location of the secure element from which the installation dataset itself is executed. For example, the installation dataset may be stored in a dedicated storage area and executed from there. At least during the installation process, only the installation dataset can access this dedicated storage arca or have corresponding access, for example through corresponding interface specifications and/or security devices. This helps to make the installation process and the provision of access to a telecommunications network using the auxiliary profile dataset secure and reliable.

According to an embodiment, the auxiliary profile data set may be configured to execute an authentication algorithm and/or enable its execution. The authentication algorithm may, for example, be a Milenage/TUAK Algo code, which may be stored in the memory area in which the installation file set and/or auxiliary profile data set is stored and executed from there. In this way, the auxiliary profile data set can be used to perform a common and proper login to a telecommunications network. In this way, the availability and data integrity of secure elements can be further improved during the execution of installation processes.

According to an embodiment, the auxiliary profile data set may be written to a non-volatile memory area. The auxiliary profile data set may be written to a memory area for user data, for example by means of so-called flashing. In the non-volatile memory area, the auxiliary profile dataset can be stored protected against corresponding voltage or power interruptions, thus preventing the auxiliary profile dataset from being accidentally lost or deleted. This helps to further improve the security, availability, and data integrity of secure elements during the execution of installation processes.

According to an embodiment, the installation dataset and/or an application dataset may be provided to query auxiliary login credentials for the auxiliary profile dataset via the telecommunications network. The auxiliary login credentials can be requested from or regenerated by a server of a network operator of the telecommunications network. In this way, an auxiliary profile dataset can be recreated to enable access to a telecommunications network based thereon. This can help improve the flexibility and reliability of establishing access when performing an installation process on the secure element.

The embodiments presented with reference to the respective method apply to the security element. The components of the security element can be each configured to perform the respective steps of the method.

### BRIEF DESCRIPTION OF THE FIGURES

FIG. 1 depicts a schematic view of an embodiment of an arrangement according to an embodiment with a user device and a server, which are configured to carry out a method for configuring the user device.

### DETAILED DESCRIPTION

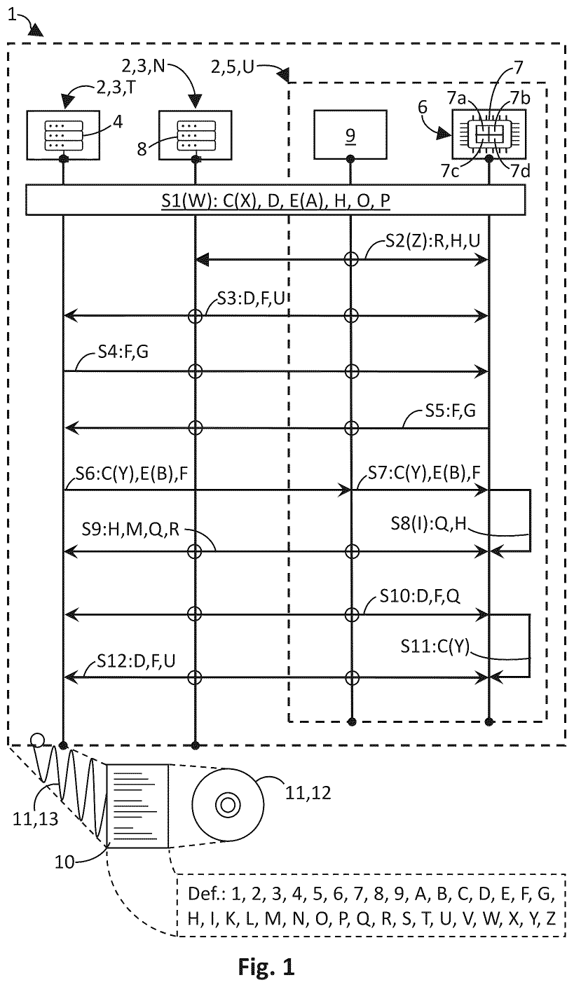

FIG. 1 shows a schematic representation of a device arrangement 1 comprising a computing device 2, for example in the form of a server device 3, which is controlled by a trusted entity T, which may contain a hardware security module 4 configured to store, administrate and/or provide operating system data sets O for configuring a further computing device 2. The additional computing device 2 may be set up as a user device 5, which may be in the form of an Internet of Things (IoT) device, such as a multimedia device, a camera, a loudspeaker, a household appliance, a measuring device, an industrial appliance, a vehicle, a vending machine or similar, which is to be associated with a machine entity, and/or as a smart card, identification card, transaction card, personal mobile device, such as a smartphone, a smartwatch, etc., which is to be assigned to a person entity. The server device 3 can, for example, be provided in the form of a server for Subscription Manager Data Preparation+(SM-DP+).

In the example, the user devices 5 can be set up for secure operation, transactions and/or communication, e.g. via a telecommunications network (not shown), by means of at least one profile dataset P of a user U or user, which is stored in a corresponding secure element 6 or tamper-proof element (TRE), such as a UICC, eUICC, iUICC, SIM, eSIM, iSIM, SE, eSE or similar, which can be provided in the form of a computer chip. The profile datasets P are generated on the basis of corresponding personal data sets contained in data files on the server device 3, in particular the hardware security module 4. To store and manage profile datasets P on the secure elements 6, an operating system dataset O is installed on the secure element 6, for example in a secure storage location 7, such as an Issuer Security Domain-Root (ISD-R), which is provided on the secure element 6. The secure storage location may have different storage areas, such as at least a first storage area 7a and at least a second storage area 7b, at least a third storage area 7c, and/or at least a fourth storage area 7d.

The operating system data set O comprises an executable data subset E, which can be provided in an earlier version A and a later version B, which define a previous version X and a subsequent version Y of an application process C, which can be configured for access to at least one data object D. The executable data subset E and/or the at least one data object D can be updated from the earlier version A to the later version B by means of an update sub-dataset F. The update process is usually carried out with the aid of an installation dataset I, e.g. a secure installation program, which can be output by the secure entity T.

The installation data set I may be provided as part of the operating system data set O. Furthermore, the user profile P and/or login credentials H or security credentials, may include login credentials H, security keys K and/or authentication certificates L. The login credentials H may include any type of credentials defined, for example, by the GSMA or similar. The security keys K may comprise any type of cryptographic code or key element that may be suitable for interaction with the user devices 5, the secure elements 6, the server device 3 of the trusted entity T as issuer of a part of the operating system data set O, the management application 8 of the network operator N, and/or a component thereof. The authentication certificates L may be, for example, any type of electronic certificate that may be issued by the trusted entity T to authenticate the origin of the user devices 5, the secure elements 6, the secure storage location 7, the management application 8, and/or the operating system data set O. Transmission lines (not shown) may be provided for handling and/or transmitting the operating system data set O, which may comprise any type of wired and/or wireless transmission chains, including the Internet (for “over-the-air” transmissions) as well as other physical and/or non-physical data carriers that can be configured and secured as desired and required by the configuration arrangement 1 and its components.

A management application 8 or home location register (HLR) may be provided, which can be configured to enable a network provider M, for example a mobile network operator (MNO), to communicate with the user device 5, in particular the secure element 6, for example directly and/or via a communication interface 9 to the user device 5. The management application 8 can be provided in the form of a remote manager, such as an eSIM IoT remote manager (eIM), which can be securely identified by means of an application identifier and/or authenticated by means of an authentication certificate. The communication interface 9 can be provided in the form of a logical end-to-end interface (e.g., ESep) that enables secure communication between the management application 8 and the secure element 6, which can be used to transmit data packets, such as eUICC packets, in order to, for example, perform profile status management and eIM configuration tasks using the eIM. The communication interface 9 can, for example, be provided as part of a local management application, such as an IoT profile assistant (IPA), which can take the form of an IoT profile assistant (IPAd) provided to the user device 5 and/or an IoT profile assistant (IPAe) located in the secure element 6. Alternatively, or additionally, the management application 8 and/or the communication interface 9 can be provided as a local profile assistant (LPA) that is made available to the user device 5 and/or is located in the secure element 6.

In embodiments of the configuration arrangement 1 described herein, the computing devices 2 and the secure element 6 in particular can be configured and adapted so that they can execute a computer program in the form of a configuration program 10. The configuration program 10 can be stored on a computer-readable data carrier 11, which can be configured as a computer-readable medium 12 and/or as a data carrier signal 13. When the configuration program 10 is executed, the security system 1 and its components communicate as specified in the security program 10. Parameters that are assigned to and/or underlying the security system 1, its components, and/or the steps S executed by it may be defined in the configuration program 10 and/or by means of it.

In a first step S1, the server device 3, in particular in a pre-issue or pre-delivery state of the user device 5 or secure element 6, can provide any data components of the configuration system 1, including the operating system data set O, possibly together with the installation program data set I, the respective diversified data, such as the security credentials H and/or the user profile P, which are assigned to the user U, to the management application 8 and/or the secure element 6 of the user device 5, for example via the communication interface 9, in order to store them for use by the network operator N or at the secure storage location 7 for use by the user U. In a second step S2, the earlier version A of the executable subset E, which contains the previous version X of the application process C, can be activated, for example by an activation signal triggered by the user U in cooperation with the management application 8 and/or the communication interface 9 using an authentication algorithm R that can use the login credentials H to enable the user device 5 to perform operations in accordance with the earlier version X and/or to communicate via a telecommunications network provided by the network provider N, whereby the user device can then be in a post-issue state Z or delivery state from which it should no longer be able to return to the pre-issue state W. In a third step S3, a communication connection F or radio connection can be established between the user device 5 or its secure element 6 on the one hand and the server devices 3 of the network operator N and/or the secure instance T on the other hand, based on the login credentials H and/or the user profile P of the user U. After activation and/or authorization by the login credentials H, the user U and/or the server devices 3 can transfer, create, and/or modify respective data objects D to and/or in the secure element 6 as required by the previous version X of a respective application process C.

In a fourth step S4, a notification signal G can be provided by the server device 3, which optionally informs the user U that an update dataset V is available for installation in the secure element 6. Together with the notification signal V, a further notification signal V in the form of a data request command for requesting and/or confirming the installation of the update dataset V for use by the user device 5 can be provided, for example by optionally allowing the user U to trigger the start of the update process by means of corresponding login credentials H to be checked in the secure element 6. In a fifth step S5, the user U can optionally request the installation of the update dataset V. In a sixth step, the update dataset V can optionally be requested by the user U by sending the notification signal G for the update request to the server device 3.

In a sixth step S6, the update dataset V can be provided by the server device 3 to the user device 5, for example by downloading via the connotation connection F and/or to the communication interface 9, so that the update data subset F is ready to be installed in the secure element 6. The update dataset V comprises the subsequent version B of the at least one executable data set E, which defines a later version Y of the application process C. In a seventh step S7, the update can be performed on the secure element 6 with the aid of the installation dataset I.

In an eighth step S8, an auxiliary dataset Q can be created, e.g., in the secure element Elements 6 using the installation dataset I. In a ninth step S9, the user U can again trigger the authentication algorithm R via interaction with the management application 8 and/or the communication interface 9, which can use the login credentials H based on the auxiliary profile dataset Q to enable the user device 5 to perform operations in accordance with the previous version X and/or communicate via a telecommunications network provided by the network provider N, whereby the user device can then remain in a post-issuance state Z or delivery state. Alternatively, or additionally, the installation dataset I and/or the application process C may request auxiliary login credentials M for the auxiliary profile dataset via the communication link F that is necessary for the use of the communication link F and/or the application process C in the previous version X, for example by regenerating them using the respective server device 3 of the network operator N and/or the secure entity T, possibly using the hardware security module 4 or the management application 8. In a tenth step S10, the communication link For radio link between user device 5 or its secure element 6 on the one hand and the server devices 3 of network operator N and/or secure entity T on the other hand can be established on the basis of the login credentials H, auxiliary login credentials M and/or the auxiliary profile dataset Q. The user U and/or the server devices 3 can optionally transfer, create and/or modify respective data objects D to and/or in the secure element 6, in particular in accordance with the predefined data format M, as required by the previous version X of a respective application process C, in order to be able to communicate or process data objects D during the ongoing installation process.

In an eleventh step S11, the update can be completed, e.g., by restarting the secure element 6. Following the successful installation or update, for example, of the operating system data set O or its corresponding executable data set E, the subsequent version B of the at least one executable data set E or the later version Y of the application process C can be executable. In a twelfth step S12, analogous to the third step S3, a communication connection or radio connection can be established between the user device 5 or its secure element 6 on the one hand and the server devices 3 of the network operator N and/or the secure instance T on the other hand, based on the login credentials H and/or the user profile P of the user U. After activation and/or authorization by the login credentials H, the user U and/or the server devices 3 can transfer, create, and/or modify respective data objects D to and/or in the secure element 6 as required by the subsequent version Y of a respective application process C.

During the process described above, no secure storage location 7 or its storage areas 7a to 7d are used to store the respective datasets or data objects described. In particular, the installation dataset I, login credentials H, and/or authentication algorithms R can be stored in the first storage arca 7a in a manner that is as unalterable and/or unlosable as possible. In particular, the operating system dataset O and/or authentication algorithms R can be stored in the second storage area 7b in a manner that is as unchangeable and/or unlosable as possible, for example by designing the second storage area as read-only memory (ROM). Profile datasets P can be stored in the third storage area 7c, which can thus be configured as user memory. Individual data can be stored in the fourth memory arca 7d, for example certain identification data as parts of the login credentials H and/or identification numbers of the profile dataset P and/or the secure element 6, for example and/or last used login credentials H, in order to be able to execute the authentication algorithm R based on this.

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” means “serving as an example, instance, or illustration.” Details of the exemplary embodiments or other limitations described above should not be read into the claims absent a clear intention to the contrary. Any implementation described herein as exemplary is not necessarily to be construed as preferred or advantageous over other implementations, and the exemplary embodiments described herein are not intended to limit the scope or applicability of the subject matter in any way. Accordingly, it should be appreciated that the exemplary embodiment or embodiments described herein are not intended to limit the scope, applicability, or configuration of the claimed subject matter in any way. Rather, the foregoing detailed description will provide those with ordinary skill in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

As an example of the wide scope of the technical features disclosed herein, an embodiment can be configured to address the following technical aspects. The methods and systems known from the prior art for providing and updating secure elements of user devices, including operating system updates, may not meet all requirements in terms of deployability and availability on the one hand and functional safety and security on the other hand. For example, it is desirable that both the operating system and the secure elements have the same origin and preferably the same development status in order to ensure functional safety and security. However, due to limitations in usability and availability, it cannot always be guaranteed that the operating system and the secure elements have the same origin and the corresponding versions or that they will meet certain future requirements, especially if a new specification or standard for the operation of user devices is expected to be introduced during the lifetime of the user device and/or the respective secure element.

Additionally, in this example, this may limit the functionality, in particular a range of (future) capabilities, of the user device, impair the functional safety and security of user devices during operation, or even result in the devices not being able to be configured correctly, bearing in mind that not only the operating system but also the associated data structures may be affected by update procedures. In order to update the range of functions of user devices and their secure elements to the latest state or to ensure an appropriate level of development, data sets operated on the secure element, such as the operating system, can be updated by means of appropriate update data sets (updates/upgrades) that can be installed on the secure element using installation programs. However, these installation processes may take a certain amount of time, such as several minutes, during which the secure element cannot be used and the user device is therefore unable to communicate. Under certain circumstances, a lack of or interrupted communication capability of the user device may be unacceptable, for example because emergency calls cannot be made from the user device or because it cannot be located in the telecommunications network.

Still further, an embodiment can be configured to improve interaction between the secure elements and their operating systems. It can provide a way of handling secure elements and their operating system in such a way that a future-proof range of functions, security, and protection can be guaranteed without impairing the usability, availability, and/or data integrity, in particular the communication capability, of the user devices or their secure elements.

Lastly, the features described herein with reference to methods and corresponding method steps may be implemented as device features or vice versa. Sections of the description relating to the method therefore also apply analogously to computer programs, computer-readable data carriers, user devices for participation in communication networks, and communication networks. In particular, method steps and related components mentioned may be implemented as functions of computer or device programs, computer-readable data carriers, and user devices for participation in communication networks. Any functions of the device or computer programs, computer-readable data carriers, user devices, and device arrangements for configuring the user devices for participation in communication networks may be implemented as process steps.

It is claimed:

1. A method for configuring a mobile user device for participation in a telecommunications network, with a secure element, in particular an eUICC, which is configured to administrate at least one profile data set for secure operation of the user device, comprising the following steps:
providing an installation dataset to accompany at least part of an installation process for installing data on the secure element; and
providing an auxiliary profile dataset enabling access to a telecommunications network while the installation dataset accompanies at least part of the installation process.

2. The method of claim 1, wherein the installation dataset is configured to carry out the installation process in a memory area of the secure element and, during this process, to store the auxiliary profile dataset in another memory area of the secure element.

3. The method of claim 2, wherein the installation dataset is configured to store login credentials required for creating the auxiliary profile dataset in a section of a secure storage location of the secure element from which the installation dataset itself is being executed.

4. The method of claim 3, wherein the auxiliary profile dataset is configured to execute an authentication algorithm and/or enable its execution.

5. The method of claim 4, wherein the auxiliary profile dataset is written in a non-volatile memory area.

6. The method of claim 5, wherein the installation dataset and an application process requests auxiliary login credentials for the auxiliary profile dataset via the telecommunications network.

7. A non-transitory computer-readable data carrier, having stored thereon a configuration program which performs a method for configuring the mobile terminal device for participation in the communications network, with a secure element, in particular an eUICC, which is configured to administrate at least one profile data set for secure operation of the user device, said method comprising:
providing an installation dataset to accompany at least part of an installation process for installing data on the secure element; and
providing an auxiliary profile dataset enabling access to a telecommunications network while the installation dataset accompanies at least part of the installation process.

8. A mobile terminal device for participation in a communications network, wherein a configuration program stored thereon performs a method for configuring the mobile terminal device for participation in the communications network, with a secure element, in particular an eUICC, which is configured to administrate at least one profile data set for secure operation of the user device, said method comprising:
providing an installation dataset to accompany at least part of an installation process for installing data on the secure element; and
providing an auxiliary profile dataset enabling access to a telecommunications network while the installation dataset accompanies at least part of the installation process.
